(19) United States
(12) Patent Application Publication
(10) Pub. No.: US 2024/0397433 A1
(43) Pub. Date: Nov. 28, 2024

(54) SELECTIVE UPLINK TRANSMISSION POWER BOOSTING FOR USER EQUIPMENT

(71) Applicant: Nokia Technologies Oy, Espoo (FI)

(72) Inventors: Karri Markus RANTA-AHO, Espoo (FI); Marco MASO, Massy (FR); Axel MUELLER, Massy (FR)

(21) Appl. No.: 18/688,766

(22) PCT Filed: Aug. 17, 2022
(86) PCT No.: PCT/EP2022/072941

§ 371 Date: Mar. 2, 2024

Related U.S. Application Data
(60) Provisional application No. 63/240,040, filed on Sep. 2, 2021.

(51) Int. Cl. H04W 52/14; H04W 52/36

(52) U.S. Cl. CPC H04W 52/146; H04W 52/36

(57) ABSTRACT

Systems, methods, apparatuses, and computer program products for selective uplink transmission power boosting for a user equipment (UE) are provided. One method may include determining, by a UE, for a given transmission or service, whether to use a first uplink transmission power or a second uplink transmission power over a radio channel bandwidth, based on obtained configuration information. The user equipment is configured to support the first uplink transmission power associated with a first power limit over the radio channel bandwidth and the second uplink transmission power associated with a second power limit over the radio channel bandwidth, and the second uplink transmission power is equal to or higher than the first uplink transmission power. The method may then include transmitting the transmission or service applying the determined first or second uplink transmission power limit.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for selective uplink transmission power boosting.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method that may include determining, by a user equipment, for a given transmission or service, whether to use a first uplink transmission power or a second uplink transmission power over a radio channel bandwidth, based on obtained configuration information. The user equipment is configured to support the first uplink transmission power associated with a first power limit over the radio channel bandwidth and the second uplink transmission power associated with a second power limit over the radio channel bandwidth, and the second uplink transmission power is equal to or higher than the first uplink transmission power. The method may then include transmitting the transmission or service applying the determined first or second uplink transmission power limit.

An embodiment may be directed to an apparatus including at least one processor and at least one memory comprising computer program code. The at least one memory and computer program code may be configured, with the at least one processor, to cause the apparatus at least to perform: determining for a given transmission or service, whether to use a first uplink transmission power or a second uplink transmission power over a radio channel bandwidth, based on obtained configuration information. The apparatus is configured to support the first uplink transmission power associated with a first power limit over the radio channel bandwidth and the second uplink transmission power associated with a second power limit over the radio channel bandwidth, and the second uplink transmission power is equal to or higher than the first uplink transmission power. The apparatus may then be caused to perform the transmitting of the transmission or service applying the determined first or second uplink transmission power limit.

An embodiment may be directed to an apparatus including means for determining, for a given transmission or service, whether to use a first uplink transmission power or a second uplink transmission power over a radio channel bandwidth, based on obtained configuration information. The apparatus may be configured to support the first uplink transmission power associated with a first power limit over the radio channel bandwidth and the second uplink transmission power associated with a second power limit over the radio channel bandwidth, and the second uplink transmission power is equal to or higher than the first uplink transmission power. The apparatus may also include means for transmitting the transmission or service applying the determined first or second uplink transmission power limit.

An embodiment may be directed to a method that may include determining, by a user equipment, for a given transmission or service, whether to boost uplink transmission power for the transmission or service over a radio channel bandwidth so that the uplink transmission power exceeds an average power of a power limit, based on obtained configuration information. The user equipment may be configured with the power limit and is capable of transmitting with higher power beyond the average power of the configured power limit. The method may also include transmitting the transmission or service with the determined uplink transmission power.

An embodiment may be directed to an apparatus including at least one processor and at least one memory comprising computer program code. The at least one memory and computer program code may be configured, with the at least one processor, to cause the apparatus at least to perform: determining, for a given transmission or service, whether to boost uplink transmission power for the transmission or service over a radio channel bandwidth so that the uplink transmission power exceeds an average power of a power limit, based on obtained configuration information. The apparatus may be configured with the power limit and is capable of transmitting with higher power beyond the average power of the configured power limit. The apparatus may also be caused to perform the transmitting of the transmission or service with the determined uplink transmission power.

An embodiment may be directed to an apparatus including means for determining, for a given transmission or service, whether to boost uplink transmission power for the transmission or service over a radio channel bandwidth so that the uplink transmission power exceeds an average power of a power limit, based on obtained configuration information. The apparatus may be configured with the power limit and is capable of transmitting with higher power beyond the average power of the configured power limit. The apparatus may also include means for transmitting of the transmission or service with the determined uplink transmission power.

An embodiment may be directed to a method that may include configuring, by a network node, at least one user equipment to utilize an uplink transmission power for a specific service or traffic type that is higher than a transmission power of a power limit configured for the at least one user equipment. The method may also include determining, by the network node, whether to activate the higher uplink transmission power for the at least one user equipment, based on previous uplink resource occupation, and transmitting an uplink grant to the at least one user equipment comprising signaling related to activation of the higher uplink transmission power for the specific service or traffic type.

An embodiment may be directed to an apparatus including at least one processor and at least one memory comprising computer program code. The at least one memory and computer program code may be configured, with the at least one processor, to cause the apparatus at least to perform: configuring at least one user equipment to utilize an uplink transmission power for a specific service or traffic type that is higher than a transmission power of a power limit configured for the at least one user equipment. The apparatus may also be caused to perform: determining whether to activate the higher uplink transmission power for the at least one user equipment, based on previous uplink resource occupation, and transmitting an uplink grant to the at least one user equipment comprising signaling related to activation of the higher uplink transmission power for the specific service or traffic type.

An embodiment may be directed to an apparatus including means for configuring at least one user equipment to utilize an uplink transmission power for a specific service or traffic type that is higher than a transmission power of a power limit configured for the at least one user equipment. The apparatus may also include means for determining whether to activate the higher uplink transmission power for the at least one user equipment, based on previous uplink resource occupation, and means for transmitting an uplink grant to the at least one user equipment comprising signaling related to activation of the higher uplink transmission power for the specific service or traffic type.

### BRIEF DESCRIPTION OF THE DRAWINGS

For proper understanding of example embodiments, reference should be made to the accompanying drawings, wherein:

FIG. 1 illustrates VoNR according to an example embodiment;

FIG. 2 illustrates an example configuration of power boosting, according to an embodiment;

FIG. 3 illustrates a signaling diagram, according to an embodiment;

FIG. 4 illustrates a signaling diagram, according to an embodiment;

FIG. 5 illustrates an example flow diagram of a method, according to an embodiment;

FIG. 6 illustrates an example flow diagram of a method, according to an embodiment;

FIG. 7 illustrates an example flow diagram of a method, according to an embodiment;

FIG. 8A illustrates an example block diagram of an apparatus, according to an embodiment; and

FIG. 8B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for selective uplink transmission power boosting for a new radio (NR) user equipment (UE), is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

A high power class, referred to as power class 2 (PC2) has been defined, which capable of 26 dBm transmission in the uplink on frequency range 1 (FR1). The PC2 UE is currently just applicable for time division duplex (TDD), and with a maximum uplink duty cycle of 50% to limit the average transmission (Tx) power to 23 dBm so that the specific absorption rate (SAR) emission limits are not exceeded. However, the applicability of PC2 may be extended to additional cases, such as aspects related to random access (RACH) and voice, in the near future. Such future coverage enhancement solutions are expected to be Frequency Range (FR) agnostic and applicable to TDD and frequency division duplex (FDD) deployments.

A UE may be restricted from using excess uplink (UL) power for various regulatory and/or health reasons. As discussed below, different kinds of duty-cycle related solutions exist for power increase. As one example, power can be increased in intervals when transmitting MSG 3 of RACH process if the initial transmission fail.

It is noted that, as discussed herein, the absorbed energy/power (SAR) or (potentially estimated) equivalent isotropic radiated energy/power, taking spatial directivity into account, i.e., effective isotropic radiated power (EIRP), can be used interchangeably. They are related via the electric field at any spatial point as follows:

$$S A R = \frac{σ {\vert E \vert}^{2}}{ρ} ,$$

where σ is conductivity of the tissue (S/m), ρ is mass density of the tissue (kg/m³), and E is rms electric field strength in tissue (V/m).

It is further noted that regulatory electromagnetic compatibility (EMC) emission limits are currently defined in terms of SAR for FR1 and EIRP for FR2. By treating transmission limits in terms of SAR or general “power” in the following, example embodiments can be applied independently of the frequency range.

Several procedure-specific bottlenecks for UL coverage may be possible in FR1 scenarios or deployments. These bottlenecks may include RACH Msg1, RACH Msg3, and the session initiation protocol (SIP) invite signaling for voice over NR (NR). More specifically, for Voice over NR (VoNR), the SIP invite signaling may require higher data rates than the actual voice traffic, e.g., due to local and sporadic throughput increases occurring when such signaling occurs. This entails a potential coverage bottleneck for voice services, such as for FDD deployments operating below 3.5 GHz. Sporadically a SIP invite packet may need to be sent in a slot (or time domain resource allocation (TDRA), which occurs once per slot in NR releases up to Release-17). Due to larger number of information bits, the SIP invite slot has higher signal-to-noise ratio (SNR) requirements to be successfully demodulated, when compared to normal voice packet slots. Since the voice connection breaks, if the high payload slot fails, this slot constitutes the coverage bottleneck in this moment.

Solutions based on power boosting at the UE may be a very convenient and attractive means to enhance the coverage of at least, but not limited to, the three aforementioned procedure-specific bottlenecks, since no specific channel enhancement would be necessary to experience the coverage increase. This could be beneficial for both TDD and FDD deployments. Indeed, in the context of coverage enhancements for FDD, a PC2 capable UE would be helpful. However, as the continuous transmission of FDD with high Tx power risks violating SAR limits, the extension of PC2 to FDD for coverage enhancement poses a challenge. Example embodiments discussed herein provide a solution that can be applied to both TDD and FDD.

In the following, certain example embodiments may be discussed in the context of the VoNR “SIP invite” packet/slot issue, for purposes of illustration. However, example embodiments are not limited to the VoNR SIP invite packet, as some embodiments can be applied more generally and are not reduced to just this embodiment.

The IP multimedia subsystem (IMS) network, used to facilitate VoIP services in NR networks, makes use of the SIP to allow a UE to establish call connections. Technically speaking, the IMS network comes with its own access point name (APN), and is thus separate from the LTE/NR network. In this context, the SIP signaling component requires its own bearer. Such bearer has an associated unique IP address and its own quality of service (QoS) class identifier (QCI). SIP signalling is exchanged between the UE and IMS Network before the beginning of a VoNR session. The size of this signalling during call setup may be about 1.5-2 kB, which is 5 to 6 times the typical VoNR packet size at physical layer (PHY). Such a size difference has been known as a potential source of coverage issues in LTE deployments as well.

It is possible that VoNR coverage may be worse than VoLTE and significantly worse than the UMTS counterpart. The coverage problem in NR may be further exacerbated by the service data adaptation protocol (SDAP) header (QoS flow handling). So-called “call drops” may be caused by higher layers (PDCP and TCP) configuration, when the PHY channels cannot deliver sufficient throughput in poor SNR conditions to transmit SIP signalling successfully. More precisely, a transmission control protocol (TCP) round trip time (RTT) and/or packet data convergence protocol (PDCP) discard timer can set a hard limit for completing the UL transmission, which requires a certain physical uplink shared channel (PUSCH) data rate in order to be met.

Depending on the configured timers (i.e., time constraints) by higher layers, example values of sufficient UL throughput are given in Table 1 below, which shows that SIP signalling may often need larger throughput than a regular VoIP packet (which typically requires around 12 kbps), depending on the higher layer configuration. Currently, the only way to mitigate the SIP invite packet loss issue at higher layer, per conventional approaches, is to increase the latency of the call setup beyond acceptable values, e.g., beyond achievable performance of UMTS networks. A coverage extension mechanism at PHY would be beneficial to reduce call setup latency at the cell edge, i.e., when the UE experiences coverage shortage.

TABLE 1

| | Time constraint | Required UL |
|---|---|---|
| Packet size (Byte) | by higher layer (ms) | data rate (kbps) |
| 1500 | 500 | 24 |
| 1500 | 750 | 12 |
| 1500 | 1500 | 8 |

Currently, as introduced above, a PC2-supporting UE is allowed to transmit with 26 dBm if the uplink duty cycle is at most 50% of a given evaluation period, provided that the average Tx power does not exceed the 23 dBm limit within the period. For this reason, regulations may refer to this evaluation period as an “averaging window”. A similar 29 dBm PC1.5 power class has been introduced with a 25% UL duty cycle limit (e.g., as provided in 3GPP TS 38.101-1). It is noted that, with respect to the 29 dBm power class PC1.5, the 29 dBm Tx power is achieved by using two 26 dBm power amplifiers. In practice, a UE may report PC2 or PC1.5 for a given band, where 26 dBm UE PC2 and 29 dBm PC1.5 exist only for TDD cases where, as discussed above, the uplink duty cycle can be capped to 50% and 25% of the evaluation period with the UL/DL pattern of the TDD configuration to ensure the average Tx power to stay within the 23 dBm limit. If 50% is exceeded by the duty cycle (TDD configuration has more UL than DL in the UL/DL pattern), the UE falls back to PC3.

It is further noted that the duty cycle (e.g., as defined in 3GPP TS38.101-1 and TS 38.101-2) is a measure that is set over a given control window, for the UE to use the higher power class (PC). A slot structure or frame configuration is defined that has a certain DL-to-UL ratio and thus a ‘duty cycle’ for the UL transmissions. If the duty cycle of this structure is set to not allow for the higher PC, then higher PC is never used. Furthermore, the duty cycle, as per definition, is meaningful in TDD deployments, whereas it is 100% in FDD deployments by definition. In other words, conventional power boosting based on duty-cycle for coverage increase, which is available for TDD, is not usable in FDD, as no means for determining the UL duty cycle in advance has been defined other than the TDD UL/DL slot configuration.

A UE may be capable of generalized time-localized power boosting, i.e., transmitting using a Tx power higher than the nominal Tx power of its PC. According to current NR specifications, this can be, but is not limited to, a UE capable of operating as a PC2 device, i.e., where the maximum output power (Pmax)=26 dBm, or a UE capable of operating as a PC1.5 device, i.e., where Pmax=29 dBm, and so on. According to conventional power boosting operations, such a UE applies the power boosting, i.e., transmits using Pmax, for all its UL transmissions, whenever certain ratio between DL:UL resources, i.e., the duty cycle, exists for a given evaluation period, slot structure, and/or frame configuration. Stated differently, currently, an NR UE can apply power boosting to its UL transmission only by changing its PC based on a (a-priori known) duty cycle to ensure regulatory requirements are met. This can be done by looking at the slot structure (UL/DL pattern) in TDD, but cannot be done for FDD as all slots are (potentially) UL slots.

As will be discussed in detail below, method(s) and system(s) of selective uplink transmission power boosting for a UE is provided. The method(s) according to certain embodiments allows high transmission (Tx) power for specific transmission types, services, slots, and/or specific channel utilization for high power capable devices, instead of allowing it according to a per duty-cycle logic and irrespective of general TDD/FDD. Also, according to example embodiments, boosting can occur in an extremely efficient way based on the actual boosting target, i.e., the configurable boostable channels and signals are not on a slot configuration. Moreover, to keep average Tx power at or below 23 dBm or any other regulatory or technically imposed power limit for high power capable UEs, which apply power boosting while ensuring compliance with the abovementioned power limit, at least two approaches are provided. In a network-assisted approach, a base station (gNB) can perform link adaptation to enable larger throughput depending on the predicted Tx power boosting, to support specific service/traffic type. Here, in an embodiment, the network can ensure that the average Tx power is kept at or below 23 dBm by scheduling the remainder of the uplink slots with less than 23 dBm or not scheduling some slots at all. According to a UE-centric approach, the UE may autonomously determine when to start/stop transmission depending on the running Tx power average calculated by the UE itself, over a pre-configured and/or specified control window, after each UL slot. A running (sometimes called “sliding”) Tx power average can be calculated by UE. For example, the running Tx power average may be calculated by UE after each slot in which an uplink transmission occurred. For example, the UE may consider the entire control window as reference interval for the average. Also, in an embodiment, the maximum applicable Tx power in the cell may be provided by the network independently of the typically applicable Tx power in the cell.

Rather than applying power boosting based on the aforementioned a-priori known “duty cycle logic”, certain embodiments can provide a selective power boosting that may be applied to some services, traffic, slots, and/or specific channel utilization, irrespective of the general TDD/FDD, slot structure, frame configuration and so on. Additionally, some embodiments may apply functionality that caps the average transmission (Tx) power should the average emission limit be violated otherwise.

According to certain embodiments, a UE applying such boosting may then operate as if it were of a higher PC, but just for certain transmission types and/or short time bursts, characterized by the actually transmitted channel (logical, transport channel or physical) or service. Other transmissions can follow the UE's nominal power class. This provides at least a benefit of providing measurable and consistent link budget (LB) improvements for the considered services/channel utilizations.

In some embodiments, the power boosting may be applicable to specific messages transmitted over channels configured as “boostable”, such as those carrying services that are known to be non-contiguous in nature, or random-access related transmissions (which are non-contiguous by definition). Conversely, in an embodiment, the power boosting might not be applied to messages or transmission types that do not meet the criteria as being “boostable.”

A UE operating according to certain embodiments described herein can use the higher transmit power for specific transmission types, services, slots and/or traffic types such as, but not limited to, random access Msg1 physical random access channel (PRACH) preamble and Msg3/MsgB physical uplink shared channel (PUSCH), specific service type power boosting, and/or specific service type link adaptation at gNB.

According to certain embodiments, for random access Msg1 PRACH preamble and Msg3/MsgB PUSCH, the UE may not transmit continuously around the time it is transmitting the Msg1/MsgA PRACH preamble or when it is scheduled to transmit Msg3/MsgB PUSCH. These transmissions have a very sporadic nature. This guarantees that no special handling would be needed for the UE to be within the average 23 dBm cap (as per current regulations), and no “duty cycle logic” would need to be accounted for. Existing signaling controlling power control behavior can be extended to support the new maximum power cap with, for example, a bit in the system information broadcast message enabling the new power cap.

For specific service type power boosting at UE, according to an embodiment, a specific service type can be allowed to be transmitted at higher power, due to, e.g., the larger payload size characterizing such service type as compared to the average payload size of other transmissions over the same channel or UL resource. Some examples may include the PUSCH instances carrying a logical channel configured as “boostable”. This may be, for example, carrying the signaling radio bearer, SIP messages, VoIP or anything else the network deems suitable. Additional examples may include: SIP invite message in the context of the VoIP call setup, where the SIP invite message's size is roughly twice as large as any another voice packet exchanged during the call and is non-contiguous in nature; variable bit-rate VoIP calls; RRC signaling; URLLC traffic type; medium access control (MAC) feedback; or layer 1 (L1) feedback.

In certain embodiments, for specific service type link adaptation at gNB, UL grants for PUSCH, which the gNB can anticipate will be transmitted by UE with power higher than 23 dBm, can be designed to meet UL throughput targets necessary to support specific service or traffic types. This can be achieved, for example, by checking received scheduling requests (SR) or buffer status reports (BSR) to detect if the UE has data linked to the designated high-priority service types awaiting to be transmitted (service mapped to a particular logical channel that is identified in the SR or BSR). This can provide evident throughput enhancements for the specific service/traffic type while not reducing UL LB as the selected MCS is transmitted with boosted Tx power.

In other words, according to certain embodiments, the power boosting may be applied on a per service and traffic type basis, rather than being applied on a per duty cycle basis. In an embodiment, if no such traffic and/or service types occur over the UL resource, then no power boosting is performed, regardless of the duty cycle or slot structure. In this context, the UE would not need to consider the duty cycle as a constraint that can never be broken. In general, the considered services and specific channel utilization for which power boosting would occur, would mostly occupy the UL resource for a period shorter than the “nominal” duty cycle itself, for a given evaluation period. As a result, the duty cycle becomes a redundant measure/concept in the context of certain embodiments. Thus, example embodiments can also be fully applicable to FDD deployments, differently from currently existing approaches.

According to certain example embodiments, at least two approaches may be used to ensure that UE behavior complies with regulatory constraints (e.g., based on the SAR). These approaches may include network-assisted method or a UE-centric method. Thus, in some embodiments, when the UE is configured to use the higher Tx power, there may be two alternative ways of ensuring that the average Tx power over the evaluation period is kept at or below 23 dBm.

An embodiment may be directed to a network-assisted approach in which the network may ensure with scheduling that the UL resource occupation of the high-power traffic type does not last for more than the portion of the evaluation period corresponding to the Pmax at which the UE would transmit at higher-power, e.g., 50% in case of Pmax=26 dBm or 25% in case of Pmax=29 dBm. In addition, the network may ensure that the average Tx power is kept at or below 23 dBm by scheduling the remainder of the uplink slots with less than 23 dBm or not scheduling some slots at all. In this regard, it is noted that the actual amount of time over which a UE may be configured for transmitting at high power could be >50% of the evaluation period because the actual Tx power is typically less than the nominal rated max Tx power, due to power reduction for signal quality maintenance reasons. For instance, nominal 26 dBm and nominal 23 dBm Tx power, used for 50% and 25% of the evaluation period, respectively, may result in an actual average transmitted power below or equal to the limit of 23 dBm. The 50% or 25% should thus be considered as an example of a possible implementation, but is not the only possible implementation. Further, certain embodiments can be used for both TDD and FDD.

Additionally or alternatively, certain embodiments may provide a UE-centric approach in which the UE can be configured to consider a control window at least as long as one radio frame. The duration of this control window can be set depending on expected traffic-service type and size of the evaluation period by regulation. For instance, the duration of the control window may be an integer divisor, larger than or equal to 1, of the size of the evaluation period. A running Tx power average can then be calculated by UE after each slot in which a uplink transmission occurred, considering the entire control window as reference interval for the average. In some embodiments, the compliance here may include counting the time used for the transmission that could use higher power, or considering the actual Tx power. In the latter case, whenever specific traffic and service type occur, the UE may transmit over granted UL slots and/or resources at a Tx power>23 dBm, provided that the running average Tx power is less than 23 dBm. Lower transmit power may be used for the remaining granted UL slots/resources, if any, in the control window. A maximum instantaneous Tx power can be identified by the UE at each slot, for any given running Tx power average value obtained over the control window. In this context, if the high-power transmission type exceeds such maximum instantaneous allowed Tx power, the UE does not transmit anything for the remaining part of the control window. Practically, this may be performed at the UE by integrating the Tx power over the control window, and if a set cap is hit, then the remainder of the control window is not used for transmission. It is noted that this can happen when the transmissions of high-power type are taking place. Conversely, if a nominal maximum Tx power as per PC3 is used all the time, the cap would not be reached.

In other words, this windowing operation by means of the control window may be needed and applied in case high-power transmission type occurs, while it may not applied for the transmissions that follow the UE's nominal PC. Again, this approach can also be used for both TDD and FDD but may be particularly useful in case of FDD, when dynamic grants are used by the gNB and the notion of UL slots as such does not exist. As outlined above, certain embodiments define a control window such that it complies with regulatory constraints, e.g., the average Tx power over a given evaluation period is kept at or below 23 dBm.

In the following, some example embodiments may be described for purposes of illustration with respect to TDD deployments and the VoNR case. However, it should be understood that example embodiments are not merely limited to TDD deployments or cases of VoNR. For instance, as discussed above, certain embodiments can also be applicable to FDD deployments.

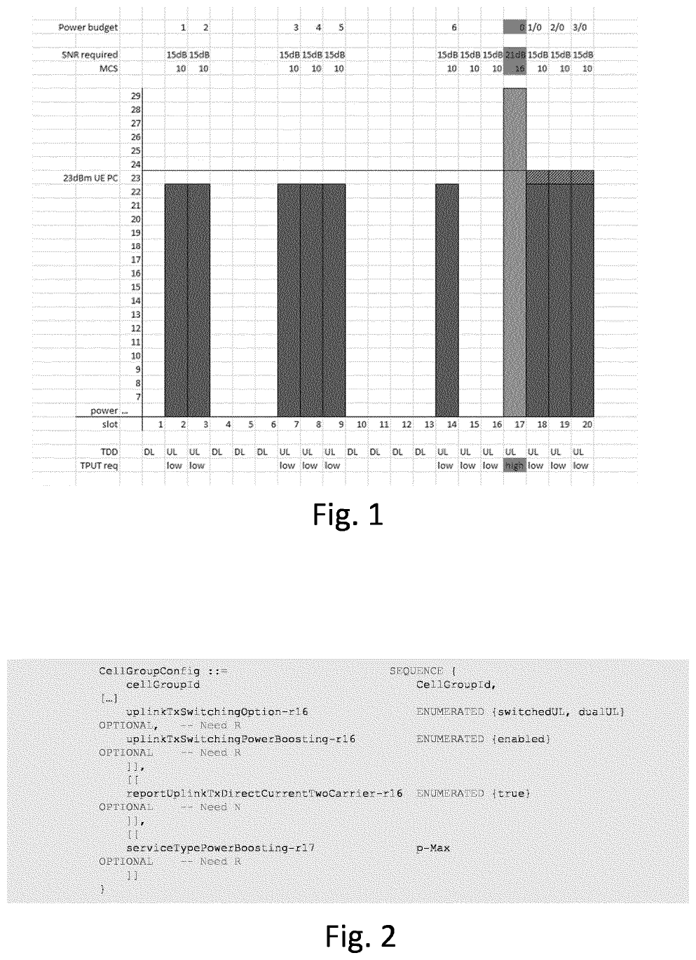

FIG. 1 illustrates a VoNR example embodiment. In this example embodiment, an uplink VoNR transmission over a certain number of slots is considered. In a typical instance of such transmission occurring in an NR deployment, most slots would carry normal packets. However, sporadic slots would carry a “SIP invite” packet. In this context, normal slots can be easily demodulated since the payload can be transmitted with a relatively low coding rate, e.g., MCS10 with 1.33 spectral efficiency (SE) and 340/1024 coding rate (CR). This packet can be successfully demodulated in case of received SNR of around 15 dB. However, to be able to fit the payload of the “SIP invite” packet, and as per discussion above, the network needs to schedule a time division resource allocation (TDRA) with higher coding rate for slots carrying such packets (e.g., MCS16: 2.57 SE; 658/1024 CR). The required SNR for successful demodulation in this case would then jump from 15 dB to 21 dB.

In the example of FIG. 1, a slot by slot representation is adopted, in which the y-axis depicts the Tx power used in each slot and where slot 17 carries the “SIP invite” packet. Not all UL slots are scheduled with an UL TDRA, so the UE power class (PC) that upper bounds the transmit power is higher than “normal” (the actual duty cycle of the UL transmission can be used to justify a higher average transmit power). Hence, it may be assumed that in the situation depicted in the example of FIG. 1, the maximum state-of-the-art power boost is already considering the indicated 23 dBm Pmax UE PC. In a situation with higher actual UL duty cycle, the maximum power boost would be lower.

To solve at least the problem outlined above, and according to the considered embodiment, the UE may be configured by the network to be allowed to perform boosting for all VoNR slots carrying SIP invite messages. In an embodiment, the maximum Tx power may be set for this specific traffic type to 29 dB.

According to some embodiments, the UE may intentionally reduce its Tx power for normal VoNR slots by 1 dB, to save up power budget and not to exceed an average Tx power of 23 dBm over the control window, in turn ensuring that no violation of regulations occurs.

Once the modulation and coding scheme (MCS) jumps to high coding rates, the UE may use as much power budget as it has accumulated to boost Tx power for this one slot, while accounting for the configured maximum boost level. In an embodiment, the UE may only use as much Tx power budget as it has, given previous slots and running average over the control window, and cannot use more than fits into the maximum boost level. This guarantees that the average transmission power per control window (e.g., per radio frame) does not exceed the limits set by the duty cycle dependent PC, for which regulations are defined.

It is noted that the UE might want to end its voluntary power back off after the high payload slot. However, this may not be recommended as the normal slots are not the coverage bottleneck and power saving is good in general, especially for battery-powered devices. The shaded blocks of FIG. 1 depict this “voluntary power back off case”, for purposes of simplicity.

It is noted that power boosting of entire slots is transparent to channel estimation and demodulation reference signals at the network. It appears like the slot had experienced a fading channel boost, and DM-RS takes such channels into account for demodulation. However, this would not necessarily be the case for per symbol, or per arbitrary time duration, based boosting. Here, the network may need to be informed where boosting was applied.

According to some embodiments, specific types of UL transmission are allowed or configured to exceed the nominal maximum Tx power. In this context, transmission type would not be related to modulation, but specifically to some features of the transmission itself. Examples of UL transmission types may include those that are not contiguously transmitted, such as messages involved in RACH procedure (e.g., Msg1/Msg3/MsgA/MsgB), RRC messages, MAC feedback, L1 feedback, SIP messages, VoNR traffic.

Certain embodiments may provide methods for defining what can be boosted. For example, in an embodiment, the network may configure a logical channel as available for boosting or “boostable”. The example services or transmission types discussed above may then be included on the configured logical channel. In this regard, it is observed that random-access related messages may be eligible (if so configured), as somewhat a different dimension, given their role.

Further, certain embodiments provide methods for the tracking of the actually transmitted boosted slots or symbols and taking action if a limit is exceeded. This may include aspects related to the definition and configuration of the control window discussed above with respect to a UE-centric approach to ensure that the average Tx power is kept at or below 23 dBm for the high-power capable UE that applies power boosting according to example embodiments. In addition, certain embodiments provide methods for guaranteeing that the power boosting can be applied to FDD deployments as well.

According to some embodiments, a maximum transmit power in the cell (p-Max) may be broadcast to the cell in SIB1 (SIB1->ServingCellConfigCommonSIB->UplinkConfigCommonSIB->FrequencyInfoUL-SIB->p-Max) and can range up to 33 dBm. It is noted that p-Max refers to the maximum transmit power value in dBm applicable for the cell (if p-Max is absent the UE applies the maximum power according to 3GPP TS 38.101-1 in case of an FR1 cell or 3GPP TS 38.101-2 in case of an FR2 cell. If p-Max is present on a carrier frequency in FR2, the UE may ignore the field and apply the maximum power according to 3GPP TS 38.101-2).

Alternatively, it may be possible to broadcast a second p-Max-RACH that can be used for RACH Msg1/MsgA and Msg3/MsgB if the UE has the capability, or broadcast a higher p-Max, and the UE is configured after initial access with p-Max=23 dBm and a p-Max-Boost of 26 or 29 dBm according to its capability. The p-Max-Boost may then be applicable to just specific services or transmissions.

Another alternative is to configure the traffic type specific boosting capable UE, using the per UE configuration framework. In this case, the boost is available after RACH (or rather RRC reconfiguration following RACH). According to this embodiment, a new RRC signal with a p-Max element, as illustrated in the example of FIG. 2 may be included.

In the example of FIG. 2, p-Max may be an integer between −30 and 33 as above and describes the maximum boost (in dB) allowable and presence of service type boosting in the first place. According to an embodiment, this value may be configured if the UE has signaled support in the UE capability container, or in systems where this feature is mandatory. In some embodiments, the numerical value for p-Max may be replaced by an “ENUMERATED {enabled}” switch. Additional service type specific signalling may also be possible according to certain embodiments. It should be noted that the specific values discussed herein for the maximum power or maximum boost, such as 23 dBm, 26 dBm, or 29 dBm, are provided as some examples. Certain embodiments are not limited to these values and may be applicable to any appropriate value. It should also be noted that all parameter names discussed above, and in the remainder of this disclosure, are provided for exemplary purposes only and should not be considered the only way to implement the corresponding example embodiments.

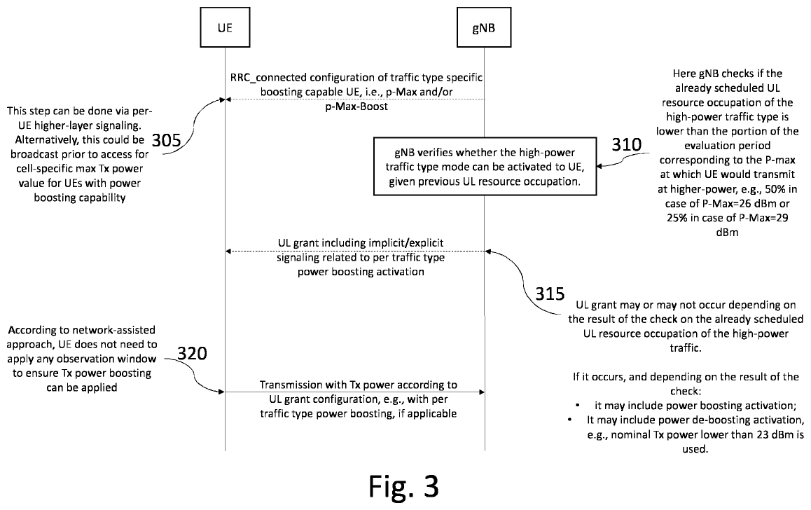

FIG. 3 illustrates an example signaling diagram of a network-assisted embodiment for RRC_connected operations. The example signaling diagram depicted in FIG. 3 may be configured to ensure that UE behavior complies with regulatory constraints (e.g., based on the SAR). As illustrated in the example of FIG. 3, at 305, the gNB may perform RRC-connected configuration of a traffic type specific boosting capable UE, i.e., p-Max and/or p-Max-Boost. The configuration at 305 may be performed via per-UE higher layer signaling or may be broadcast prior to access for cell-specific maximum Tx power value for UEs with power boosting capability. At 310, the gNB may verify whether the high-power traffic type mode can be activated to the UE, given previous UL resource occupation. For example, at 310, the gNB may check if the already scheduled UL resource occupation of the high power traffic type is lower than the portion of the evaluation period corresponding to the p-Max at which the UE would transmit at higher power, e.g., 50% in case of p−Max=26 dBm or 25% in case of p−Max=29 dBm.

As further illustrated in the example of FIG. 3, at 315, the gNB may transmit an UL grant including implicit or explicit signaling related to per traffic type power boosting activation. In an embodiment, the UL grant may or may not occur depending on the result of the check at 310 on the already scheduled UL resource occupation of the high-power traffic. If the UL grant occurs, and depending on the result of the check at 310, the UL grant may include one or more of: power boosting activation, and/or power de-boosting activation, e.g., as one example, nominal Tx power lower than 23 dBm may be used. In an embodiment, at 320, the UE may perform transmission with Tx power according to the UL grant configuration, e.g., with per traffic type power boosting, if applicable. In this example, according to an embodiment, the UE does not necessarily need to apply a control window to ensure that Tx power boosting can be applied.

However, in some embodiments, the UE can be configured to consider a control window at least as long as one radio frame. The duration of the control window can be set depending on expected traffic-service type and size of the evaluation period by regulation. For instance, in one embodiment, the duration of the control window may be an integer divisor, larger than or equal to 1, of the size of the evaluation period. In certain embodiments, the UE may be configured to calculate a running Tx power average after each slot in which a uplink transmission occurred, considering the entire control window as reference interval for the average. Thus, according to an embodiment, the UE may autonomously determine when to start/stop the transmission depending on the running Tx power average calculated by the UE itself, after each UL slot, as discussed above.

It should be noted that reference to “activated” or “activation” herein may refer to the activation of a feature, as in the feature is activated, e.g., in configuration, but not yet triggered. Additionally or alternatively, reference to “activated” or “activation” may refer to the activation and/or triggering of a feature, as in the feature is triggered with or without activation.

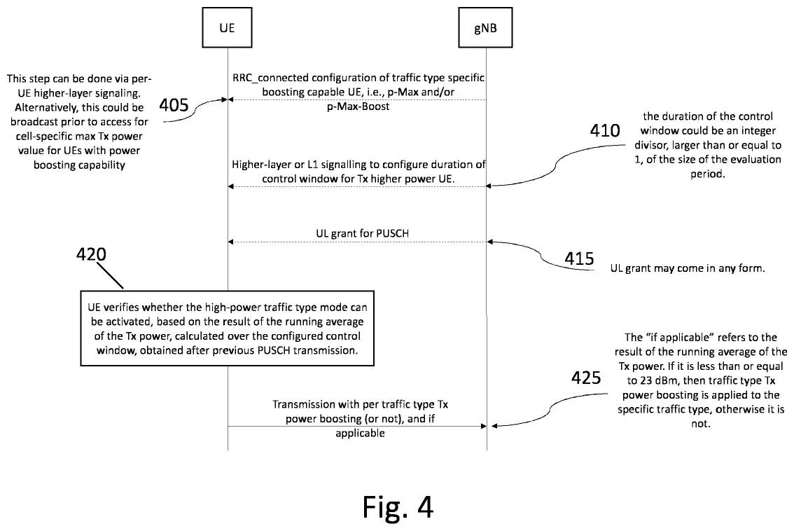

FIG. 4 illustrates another example signaling diagram of a UE-centric embodiment, according to certain embodiments. The example signaling diagram depicted in FIG. 4 may be configured to ensure that UE behavior complies with regulatory constraints (e.g., based on the SAR). As illustrated in the example of FIG. 4, at 405, the gNB may perform RRC-connected configuration of a traffic type specific boosting capable UE, i.e., p-Max and/or p-Max-Boost. The configuration at 405 may be performed via per-UE higher layer signaling or can be broadcast prior to access for cell-specific maximum Tx power value for UEs with power boosting capability. At 410, the gNB may transmit higher layer or L1 signaling to configure a duration of a control window for Tx higher power UE. In some embodiments, the duration of the control window can be an integer divisor, which may be larger than or equal to 1, of the size of the evaluation period.

As further illustrated in the example of FIG. 4, at 415, the gNB may transmit an UL grant for PUSCH to the UE. At 420, the UE may verify whether the high power traffic type mode can be activated, based on a result of the running average of the Tx power, calculated over the configured control window, obtained after previous PUSCH transmission. The UE may, at 425, transmit with per traffic type Tx power boosting (or not), and if applicable. The reference to “if applicable” may refer to the result of the running average of the Tx power. For example, if it is less than 23 dBm, then the traffic type Tx power boosting is applied to the specific traffic type, and otherwise it is not.

It should be noted that, in some embodiments, the methods illustrated in the example signaling diagrams of FIGS. 3 and 4 can be implemented separately, according to which the UE is configured to use higher Tx power for specific traffic type, while guaranteeing that average Tx power over the evaluation period is kept at or below an upper limit for transmission power (e.g., 23 dBm). However, in other embodiments, the methods illustrated in the examples of FIGS. 3 and 4 can be combined.

As noted above, the power values of 23 dBm, 26 dBm, or 29 dBm, as discussed in connection with FIGS. 3 and 4 are provided as some examples. Other embodiments may be applicable to any appropriate power values, and are not limited to just these examples.

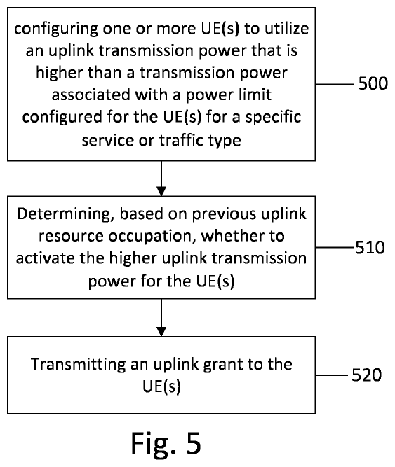

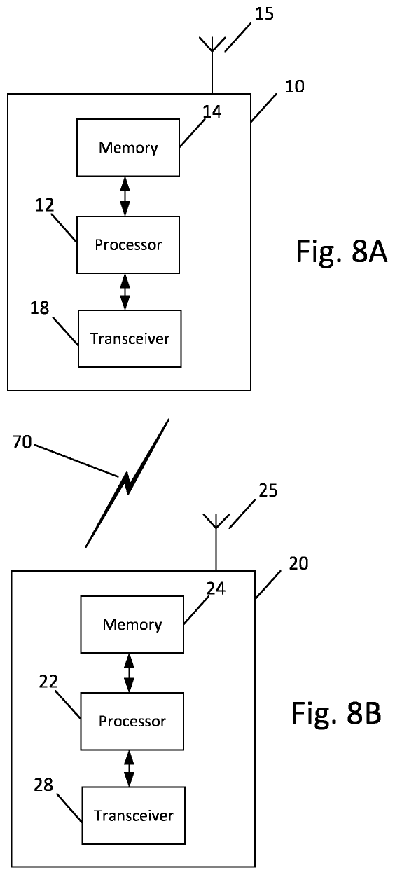

FIG. 5 illustrates an example flow diagram of a method for selective uplink transmission power boosting, according to one embodiment. In certain example embodiments, the flow diagram of FIG. 5 may be performed by a network entity or network node in a communications system, such as LTE or 5G NR. In some example embodiments, the network entity performing the method of FIG. 4 may include or be included in a base station, access node, node B, eNB, gNB, NG-RAN node, transmission-reception points (TRPs), high altitude platform stations (HAPS), relay station or the like. For example, according to certain embodiments, the entity performing the method of FIG. 4 may include a gNB, such as those illustrated in the examples of FIG. 3 or 4, or any other entity discussed herein. In some embodiments, the network node or entity performing the method of FIG. 5 may operate in FDD and/or TDD systems. In some embodiments, the example of FIG. 5 may illustrate example operations of a network node corresponding to apparatus 10 as illustrated in, and described with respect to, FIG. 8A.

As illustrated in the example of FIG. 5, the method may include, at 500, configuring one or more UE(s) to utilize an uplink transmission power that is higher than a transmission power associated with a power limit configured for the UE(s) for a specific service or traffic type. Thus, in certain embodiments, a UE may be configured with an uplink transmission power of a power limit configured for the UE and with a second uplink transmission power that is higher than the configured transmission power of the power limit configured for the UE. In one embodiment, the power limit may be a power class for instance. Thus, for example, a first uplink transmission power may be associated with a first power class and a second uplink transmission power, higher than or equal to the first uplink transmission power, may be associated with a second power class. Therefore, as discussed herein, the UE may act, for specific service or traffic type, as a device with higher power class than for some other service(s) or traffic type(s). For example, in some embodiments, the specific service or traffic type may include one or more of random access messages, radio resource control (RRC) messages, medium access control (MAC) feedback, layer 1 (L1) feedback, session initiation protocol (SIP) messages, or voice over new radio (VoNR) traffic.

As further illustrated in the example of FIG. 5, the method may include, at 510, determining, based on previous uplink resource occupation, whether to activate the higher uplink transmission power for the UE(s). The method may also include, at 520, transmitting an uplink grant to the UE(s). The uplink grant may include signaling related to activation of the higher uplink transmission power for the specific service or traffic type. In some example embodiments, the signaling related to the activation of the higher UL transmission power may be explicit signaling or may be implicit signaling. For example, the implicit signaling may include anything that is in the DCI that can be linked to causing the activation.

In an embodiment, the method may include receiving transmission, from the UE(s), with a transmission power according to the uplink grant. According to certain embodiments, the receiving of the transmission may include receiving the transmission, from the UE(s), using the higher transmission power when the uplink grant indicated activation of the higher uplink transmission power for the specific service or traffic type. Further, according to some embodiments, the method may include maintaining an average of the higher uplink transmission power at or below an upper limit. In one example embodiment, the upper limit may be a maximum regulatory limit for transmission power, as discussed above. According to an embodiment, the maintaining of the average of the higher uplink transmission power at or below the upper limit may include transmitting, to the UE(s), an uplink grant scheduling at least one of the remainder of the uplink slots with less than the upper limit, with reduced time allocation, or not scheduling some slots at all.

It is noted that FIG. 5 is provided as one example embodiment of a method or process. However, certain embodiments are not limited to this example, and further examples are possible as discussed elsewhere herein.

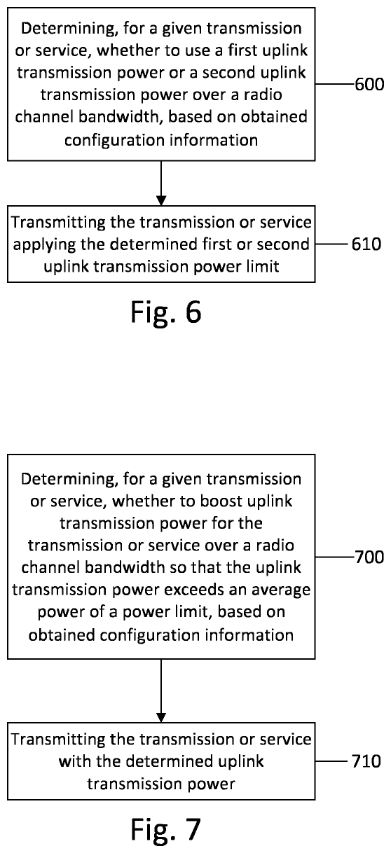

FIG. 6 illustrates an example flow diagram of a method of selective uplink transmission power boosting, according to one example embodiment. In certain example embodiments, the flow diagram of FIG. 6 may be performed by a communication device in a communications system, such as LTE or 5G NR. For instance, in some example embodiments, the communication device performing the method of FIG. 6 may include a UE, sidelink (SL) UE, wireless device, mobile station, IoT device, UE type of roadside unit (RSU), other mobile or stationary device, or the like. In some embodiments, the example of FIG. 6 may illustrate example operations of a UE corresponding to apparatus 20 as illustrated in, and described with respect to, FIG. 8B. According to an embodiment, the UE performing the method of FIG. 6 may be configured to operate in TDD and/or FDD systems.

As illustrated in the example of FIG. 6, the method may include, at 600, determining, by a UE, for a given transmission or service, whether to use a first uplink transmission power or a second uplink transmission power over a radio channel bandwidth, based on obtained configuration information. According to an embodiment, the UE may be configured to support the first uplink transmission power associated with a first power limit over the radio channel bandwidth and the second uplink transmission power associated with a second power limit over the radio channel bandwidth. In one embodiment, the second uplink transmission power may be equal to or higher than the first uplink transmission power.

As further illustrated in the example of FIG. 6, the method may include, at 610, transmitting the transmission or service by applying or using the determined first or second uplink transmission power limit. In an embodiment, when it is determined to use the second uplink transmission power, the transmitting 610 may include transmitting the transmission or service over at least one channel configured for carrying the second uplink transmission power associated with the second power limit.

According to an embodiment, the determining 600 may include determining to use the second uplink transmission power when a type of the transmission or service comprises a certain type of transmissions or services that are configured to use the second uplink transmission power associated with the second power limit.

In some embodiments, the first power limit may be a first power class and the second power limit may be a second power class, or one of the first power limit or the second power limit may be a power class and the other of the first power limit or the second power limit may be derived from the first power limit by applying an offset.

In certain embodiments, the specific service or traffic type may include one or more of random access messages, radio resource control (RRC) messages, medium access control (MAC) feedback, layer 1 (L1) feedback, session initiation protocol (SIP) messages, or voice over new radio (VoNR) traffic.

According to some embodiments, the method may include maintaining an average uplink transmission power at or below an upper limit for transmission power, where the upper limit is a lower one of the first power limit and the second power limit. In an embodiment, the maintaining of the average uplink transmission power at or below the upper limit may include receiving an uplink grant, from a network node, scheduling at least one of the remainder of the uplink slots with less than the upper limit, with reduced time allocation, or not scheduling some slots at all.

In certain embodiments, the method may include the maintaining of the average uplink transmission power at or below the upper limit may include calculating, by the UE, a running transmission power average after each slot in which an uplink transmission occurred, considering an entire control window as a reference interval for the transmission power average. In an embodiment, when the running transmission power average is less than the upper limit, the transmitting 610 may include transmitting the transmission or service with the second uplink transmission power applying the second power limit. In an embodiment, when the running transmission power average is greater than the upper limit, the transmitting 610 may include transmitting the transmission or service with a transmission power associated with a lower power limit than the second power limit or skipping the transmitting of the transmission or service. According to one embodiment, a duration of the control window may be set depending on the type of the transmission or service and a size of an evaluation period set for the upper limit.

It is noted that FIG. 6 is provided as one example embodiment of a method or process. However, certain embodiments are not limited to this example, and further examples are possible as discussed elsewhere herein.

FIG. 7 illustrates an example flow diagram of a method of selective uplink transmission power boosting, according to one example embodiment. In certain example embodiments, the flow diagram of FIG. 7 may be performed by a communication device in a communications system, such as LTE or 5G NR. For instance, in some example embodiments, the communication device performing the method of FIG. 7 may include a UE, sidelink (SL) UE, wireless device, mobile station, IoT device, UE type of roadside unit (RSU), other mobile or stationary device, or the like. In some embodiments, the example of FIG. 7 may illustrate example operations of a UE corresponding to apparatus 20 as illustrated in, and described with respect to, FIG. 8B. According to an embodiment, the UE performing the method of FIG. 7 may be configured to operate in TDD and/or FDD systems.

As illustrated in the example of FIG. 7, the method may include, at 700, determining, by a UE for a given transmission or service, whether to boost uplink transmission power for the transmission or service over a radio channel bandwidth so that the uplink transmission power exceeds an average power of a power limit, based on obtained configuration information. In an embodiment, the UE may be configured with the power limit and is capable of transmitting with higher power beyond the average power of the configured power limit. According to an embodiment, the method may then include, at 710, transmitting the transmission or service with the determined uplink transmission power. In some embodiments, the method may include receiving, from a network node, the configuration information including an indication of which transmissions or services should be transmitted with the higher power.

According to certain embodiments, when it is determined to boost the uplink transmission power, the transmitting 710 may include transmitting the transmission or service over at least one channel configured for carrying the boosted uplink transmission power that exceeds the average power of the power limit configured for the user equipment. In an embodiment, the determining 700 may include determining to boost the uplink transmission power when a type of the transmission or service comprises a certain type of transmissions or services that are configured to use the boosted uplink transmission power that exceeds the average power of the power limit configured for the UE. In one example embodiment, the configured power limit may be a power class.

As discussed above, examples of the specific service or traffic type may include random access messages, radio resource control (RRC) messages, medium access control (MAC) feedback, layer 1 (L1) feedback, session initiation protocol (SIP) messages, and/or voice over new radio (VoNR) traffic.

In some embodiments, the method may include maintaining an average of the boosted uplink transmission power at or below an upper limit for transmission power. For instance, in certain embodiments, the upper limit for transmission power may include a maximum limit as provided by state or country regulations, for example. According to an embodiment, the maintaining of the average of the boosted uplink transmission power at or below the upper limit may include receiving an uplink grant, from a network node, which schedules at least one of a remainder of the uplink slots with less than the upper limit, with reduced time allocation, or not scheduling some of the slots at all. In one embodiment, the maintaining of the average of the boosted uplink transmission power at or below the upper limit may include calculating, by the UE, a running transmission power average after each slot in which an uplink transmission occurred, considering an entire control window as a reference interval for the transmission power average.

According to certain embodiments, when the transmission power average is less than the upper limit, the transmitting 710 may include transmitting the transmission or service with the boosted uplink transmission power. In an embodiment, when the transmission power average is greater than the upper limit, the transmitting 710 may include transmitting the transmission or service with a transmission power that is lower than the average power of the configured power limit or skipping the transmitting of the transmission or service. According to one embodiment, the duration of the control window is set depending on the type of the transmission or service and a size of an evaluation period set for the upper limit.

It is noted that FIG. 7 is provided as one example embodiment of a method or process. However, certain embodiments are not limited to this example, and further examples are possible as discussed elsewhere herein.

FIG. 8A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 8A.

As illustrated in the example of FIG. 8A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 8A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding ofindividual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, JAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIG. 3-7, or any other method described herein. In some embodiments, as discussed herein, apparatus 10 may be configured to perform a procedure relating to the selective boosting or increasing of uplink transmission power, for example.

FIG. 8B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 8B.

As illustrated in the example of FIG. 8B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 8B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIG. 3-7, or any other method described herein. For example, in an embodiment, apparatus 20 may be controlled to perform a process relating to the selective boosting or increasing of uplink transmission power, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, according to example embodiments, high Tx power is allowed for specific transmission types and/or services for high-power capable devices, instead of allowing it according to a per duty-cycle logic. Certain embodiments can guarantee that the boosting occurs in an extremely efficient way based on the actual “boosting target”, i.e., the configurable “boostable” channels and signals considered herein, and not on a slot configuration which may be poorly optimized for meeting performance requirements for the “boosting target” themselves, and their corresponding services. In other words, example embodiments guarantee that the power boosting is applied when needed the most; whereas using the duty-cycle approach does not provide any guarantee that the boosting is applied when needed the most, neither functionally (due to the nature of the signal) nor instantaneously. More specifically, certain embodiments provide methods for how the average Tx power is kept at or below an upper limit, such as 23 dBm for example, for the high-power capable UE that applies power boosting according to example embodiments. A network-assisted approach, according to some embodiments, provides a method for how a gNB can perform link adaptation to enable larger throughput depending on the predicted Tx power boosting, to support specific service/traffic type. A UE-centric approach, according to some embodiments, provides a method for how a UE can autonomously determine when to start/stop transmission depending on the running Tx power average calculated by the UE itself, after each UL slot.

Furthermore, certain embodiments allow for a subset of services to be boosted, for example depending on their nature, e.g., non-contiguous, and/or their role, e.g., access-related, and count the boosted slots or symbols over a control window and take action if the transmissions exceed a set limit within that control window. In some embodiments, high Tx power as the maximum applicable Tx power in the cell may be provided by network independently of the ‘typical applicable Tx power’ in the cell (e.g., current 26 and 29 dBm power limits can be used for simplicity, based on the assumption that they can be always applied and the TDD configuration ensures sufficiently low UL duty cycle). As discussed above, power boosting according to certain embodiments can be applied to FDD deployments, as well as TDD, with no foreseeable limitations or constraints. Accordingly, the use of certain example embodiments results in improved functioning of communications networks and their nodes, such as base stations, eNBs, gNBs, and/or IoT devices, UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

PARTIAL GLOSSARY:

| | |
|---|---|
| APN | Access point name |
| BSR | Buffer status report |
| CR | Coding rate |
| DL | Downlink |
| DM-RS | Demodulation reference signal |
| EIRP | Effective isotropic radiated power |
| EMC | Electromagnetic compatibility |
| FDD | Frequency-division duplexing |
| FR | Frequency range |
| IMS | IP multimedia subsystem |
| IoT | Interference over thermal |
| IP | Internet protocol |
| L1 | Layer 1 |
| LB | Link budget |
| LTE | Long term evolution |
| MAC | Medium access control |
| MCS | Modulation and coding scheme |
| NR | New radio |
| PC | Power class |
| PDCP | Packet data convergence protocol |
| PHY | Physical layer |
| PRACH | Physical random-access channel |
| PUCCH | Physical uplink control channel |
| PUSCH | Physical uplink shared channel |
| RF | Radio frequency |
| QCI | QoS class identifier |
| QoS | Quality of service |
| RACH | Random access channel |
| RLC | Radio link control |
| RRC | Radio resource configuration |
| RSRP | Reference signal received power |
| RTT | Round trip time |
| SAR | Specific absorption rate |
| SDAP | Service data adaptation protocol |
| SE | Spectral efficiency |
| SIB | System information block |
| SIP | Session initiation protocol |
| SNR | Signal to noise ratio |
| SR | Scheduling request |
| TCP | Transmission control protocol |
| TDD | Time-division duplexing |
| TDRA | Time domain resource allocation |
| UL | Uplink |
| UMTS | Universal mobile telecommunications system |
| URLLC | Ultra-reliable low latency communications |
| VoIP | Voice over IP |
| VoNR | Voice over NR |

1. A method, comprising:
determining, by a user equipment, for a given transmission or service, whether to use a first uplink transmission power or a second uplink transmission power over a radio channel bandwidth, based on obtained configuration information,
wherein the user equipment is configured to support the first uplink transmission power associated with a first power limit over the radio channel bandwidth and the second uplink transmission power associated with a second power limit over the radio channel bandwidth, and wherein the second uplink transmission power is equal to or higher than the first uplink transmission power; and
transmitting the transmission or service applying the determined first or second uplink transmission power limit.

2. The method of claim 1, wherein, when it is determined to use the second uplink transmission power, the transmitting comprises transmitting the transmission or service over at least one channel configured for carrying the second uplink transmission power associated with the second power limit.

3. The method of claim 1, wherein the determining comprises determining to use the second uplink transmission power when a type of the transmission or service comprises a certain type of transmissions or services that are configured to use the second uplink transmission power associated with the second power limit.

4. The method of claim 1, wherein the first power limit comprises a first power class and the second power limit comprises a second power class, or wherein one of the first power limit and second power limit comprises a power class and an other of the first power limit and second power limit is derived from the first power limit by applying an offset.

5. The method of claim 1, wherein the certain type of transmissions or services comprise at least one of:
random access messages;
radio resource control (RRC) messages;
medium access control (MAC) feedback;
layer 1 (L1) feedback comprising at least one of HARQ-ACK, CSI or SRS;
session initiation protocol (SIP) messages; or
voice over new radio (VoNR) traffic.

6. The method of claim 1, further comprising maintaining an average uplink transmission power at or below an upper limit for transmission power, wherein the upper limit is a lower one of the first power limit and the second power limit.

7. The method of claim 6, wherein the maintaining comprises:
receiving an uplink grant, from a network node, scheduling at least one of the remainder of the uplink slots with less than the upper limit, with reduced time allocation, or not scheduling some slots at all.

8. The method of claim 6, wherein the maintaining comprises:
calculating, by the user equipment, a running transmission power average after each slot in which an uplink transmission occurred, considering an entire control window as a reference interval for the transmission power average.

9. The method of claim 8, wherein, when the running transmission power average is less than the upper limit, the transmitting comprises transmitting the transmission or service with the second uplink transmission power applying the second power limit.

10. The method of claim 8, wherein, when the running transmission power average is greater than or equal to the upper limit, the transmitting comprises transmitting the transmission or service with a transmission power associated with a lower power limit than the second power limit or skipping the transmitting of the transmission or service.

11. The method of claim 8, wherein a duration of the control window is set depending on the type of the transmission or service and a size of an evaluation period set for the upper limit.

12. The method of claim 1, wherein the user equipment is configured to operate in at least one of frequency division duplex (FDD) or time division duplex (TDD) systems.

13. A method, comprising:
determining, by a user equipment, for a given transmission or service, whether to boost uplink transmission power for the transmission or service over a radio channel bandwidth so that the uplink transmission power exceeds an average power of a power limit, based on obtained configuration information,
wherein the user equipment is configured with the power limit and is capable of transmitting with higher power beyond the average power of the configured power limit; and
transmitting the transmission or service with the determined uplink transmission power.

14. The method of claim 13, further comprising receiving the configuration information, from a network node, comprising an indication of which transmissions or services should be transmitted with the higher power.

15. The method of claim 13, wherein, when it is determined to boost the uplink transmission power, the transmitting comprises transmitting the transmission or service over at least one channel configured for carrying the boosted uplink transmission power that exceeds the average power of the power limit configured for the user equipment.

16. The method of claim 13, wherein the determining comprises determining to boost the uplink transmission power when a type of the transmission or service comprises a certain type of transmissions or services that are configured to use the boosted uplink transmission power that exceeds the average power of the power limit configured for the user equipment.

17. The method of claim 13, wherein the configured power limit comprises a power class.

18. The method of claim 13, wherein the certain type of transmissions or services comprise at least one of:
random access messages;
radio resource control (RRC) messages;
medium access control (MAC) feedback;
layer 1 (L1) feedback;
session initiation protocol (SIP) messages; or
voice over new radio (VoNR) traffic.

19. The method of claim 13, further comprising maintaining an average of the boosted uplink transmission power at or below an upper limit for transmission power.

20-32. (canceled)

33. An apparatus, comprising:
at least one processor; and
at least one memory comprising computer program code,
the at least one memory and computer program code configured, with the at least one processor, to cause the apparatus at least to perform:
determine for a given transmission or service, whether to use a first uplink transmission power or a second uplink transmission power over a radio channel bandwidth, based on obtained configuration information,
wherein the apparatus is configured to support the first uplink transmission power associated with a first power limit over the radio channel bandwidth and the second uplink transmission power associated with a second power limit over the radio channel bandwidth, and wherein the second uplink transmission power is equal to or higher than the first uplink transmission power; and
transmit the transmission or service applying the determined first or second uplink transmission power limit.

34-36. (canceled)
